(19) United States
(12) Patent Application Publication
(10) Pub. No.: US 2024/0147925 A1
(43) Pub. Date: May 9, 2024

(54) AEROPONICS CONTAINER AND AEROPONICS SYSTEM

(71) Applicant: V-FRM S.R.L., Rovereto (Trento) (IT)

(72) Inventor: Andrea GUGLIELMI, Rovereto (Trento) (IT)

(21) Appl. No.: 18/549,987

(22) PCT Filed: Mar. 11, 2022
(86) PCT No.: PCT/IB2022/052202

§ 371 Date: Sep. 11, 2023

(30) Foreign Application Priority Data
Mar. 11, 2021 (IT) 102021000005702

(51) Int. Cl. A01G 31/06; A01G 31/00

(52) U.S. Cl. CPC A01G 31/06; A01G 2031/006

(57) ABSTRACT

The present invention generically relates to an aeroponics container for an aeroponics system. The aeroponics container comprises a tray having a non-level bottom and walls defining an opening opposite the bottom, wherein at least two opposite walls have wings extending away from the opening, wherein a drainage outlet is positioned in a depression zone in the non-level bottom; and a planar cover configured to have at least one orifice for receiving a plant holder, wherein the cover is removably mountable on the tray so as to cover the opening.

### TECHNICAL FIELD

This invention relates to the field of horticultural systems and methods, in particular aeroponics systems and methods, and more in particular to aeroponics systems and methods aimed at reducing water consumption and energy consumption in the cultivation of plants.

### STATE OF THE ART

Aeroponics is a plant-growing technique where plants are suspended in a substrate such that the stems, leaves and any fruit grow in a vegetative area above the substrate layer. The roots dangle beneath the substrate layer in a root zone. The dangling roots receive water and other nutrients through an atomised spray of water that is rich in nutritive substances, commonly called a “nutrient solution”. In aeroponics systems, plants can be grown in a closed environment or semi-closed environment.

During operation, high-pressure aeroponics systems pressurise the nutrient solution and spray it through an atomiser or nebuliser that aerosolises the nutrient solution directly in the root zone. In this manner, aeroponics offers significant advantages over hydroponics (which uses a liquid culture medium) and geoponics (which uses soil or another aggregate material as the culture medium).

Aeroponics systems provide many desirable advantages over growing systems based on a support means. For example, aeroponics culture increases aeration and provides more oxygen to the plant roots, thus stimulating growth and helping to prevent the formation of pathogenic agents. Aeroponics can also limit disease transmission, as plant-to-plant contact is reduced. Given the disease-free environment, an exclusive characteristic of aeroponics, many plants can grow at higher densities compared to traditional forms of cultivation such as soil-based or hydroponic cultivation.

In aeroponics systems, use is made of various types of substrate layers and aeroponics containers.

The layers and containers of an aeroponics system will generally be adapted to the plant to be cultivated. For example: plant shoots (for example, they are best grown in aeroponics using a metal net or screen as a substrate layer for wholesale cultivation). However, aromatic herbs and other green leafy vegetables are preferably grown individually in plant holders. Accordingly, the configuration of the substrate layer, aeroponics container, spray or nebulisation system will vary according to the support structure used since, among other things, the distribution of plant roots is typically different in one support means compared to another.

Aeroponics systems and methods for the operation of such systems are generally known. These systems provide various degrees of success. However, the aeroponics systems presently available also show limitations, including limitations tied to operating ease or efficiency and maintenance and limitations as to water efficiency and energy efficiency. Therefore, there is a continuous need for aeroponics culture systems that offer improvements in the above-mentioned aspects.

The present invention is aimed, at least in part, at improving or surpassing one or more aspects of the prior art system.

### BRIEF SUMMARY OF THE INVENTION

The present invention relates generically to an aeroponics container for an aeroponics system. The aeroponics container comprises a tray having a non-level bottom and walls defining an opening opposite the bottom, wherein at least two opposite walls have wings extending away from the opening, wherein a drainage outlet is positioned in a depression zone in the non-level bottom; and a planar cover configured to have at least one orifice to receive a plant holder or roots of a plant, wherein the cover is removably mountable on the tray so as to cover the opening.

One object is to assure an efficient collection of the excess nutrient solution for water recycling.

According to another aspect, the present invention generically relates to an aeroponics system comprising at least one aeroponics container; at least one tank for a nutrient solution; a supporting frame comprising at least one compartment having a light source and a reflective side panel, wherein the aeroponics container is positioned in the compartment; and a circulation manifold for distribution and return of the nutrient solution between the tank and the aeroponics container.

One object is to provide an improved aeroponics system capable of operating in horizontal expansion or vertical expansion. Another objective is to provide an expandable aeroponics system that uses a minimum of water and nutrients and still reaches maximum plant growth. A further object of the invention is to reduce energy demand while at the same time assuring an adequate plant growth.

According to yet another aspect, the present invention generically relates to a method for recycling the nutrient solution in the aeroponics system. The method comprises the steps of: initiating a circulation cycle comprising: selecting a tank or one of a plurality of tanks, each tank containing a predetermined nutrient solution; selecting one of a plurality of aeroponics sectors, each aeroponics sector comprising a plurality of aeroponics containers, wherein each aeroponics container comprises at least one plant holder; fluidly connecting the selected tank to the selected aeroponics sector through a distribution manifold; fluidly connecting the selected aeroponics sector to the selected tank through a return manifold; pumping the nutrient solution from the selected tank to the selected aeroponics sector through the distribution manifold over a predetermined first time period; fluidly disconnecting the selected tank from the selected aeroponics sector through the distribution manifold at the expiry of the first time period; and fluidly disconnecting the selected aeroponics sector from the selected tank through the return manifold at the expiry of a predetermined second time period; and re-initiating the circulation cycle, wherein the same tank and aeroponics sector are selected, a different tank is selected, a different aeroponics sector is selected or a different tank and a different aeroponics sector are selected.

One object is to provide a gradual delivery of the nutrient solution (nutrient solutions) to the plants of the various aeroponics sectors.

### BRIEF DESCRIPTION OF THE DRAWINGS

The foregoing and other features and advantages of the present invention will be understood more completely from the following description of various embodiments, when read together with the appended drawings, in which:

FIG. 1 is an isometric view of an aeroponics container according to the invention;

FIG. 2 is an exploded side view of the aeroponics container according to the invention;

FIG. 3 is a plan view of the tray of the aeroponics container according to the invention;

FIG. 4 is an end view of one embodiment of the tray of the aeroponics container according to the invention;

FIG. 5 is a bottom view of one embodiment of the tray in FIG. 4;

FIG. 6 is an end view of an alternative embodiment of the tray of the aeroponics container according to the invention;

FIG. 7 is a side view of one embodiment of the tray of the aeroponics container according to the invention;

FIG. 8 is a plan view of the cover of the aeroponics container according to the invention;

FIG. 9 is a schematic plan view of the aeroponics system according to the invention;

FIG. 10 is a schematic side view of the aeroponics system according to the invention;

FIG. 11 is an isometric view of a portion of a compartment of the aeroponics system according to the invention;

FIG. 12 is a flow diagram of a method for recycling the nutrient solution with the aeroponics system according to the invention; and

FIG. 13 is a schematic view of the aeroponics system involved in the method for recycling the nutrient solution of FIG. 12.

### DETAILED DESCRIPTION

This invention generically relates to an aeroponics system for cultivating plants and to an aeroponics container for providing a substrate support to the plants that have roots suspended in air.

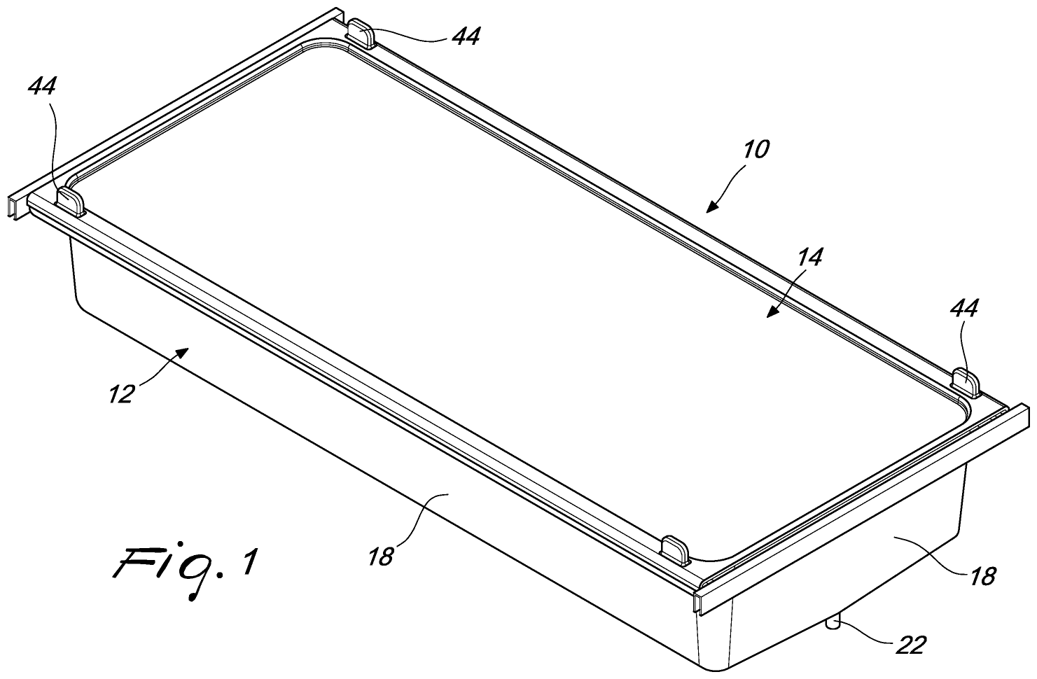

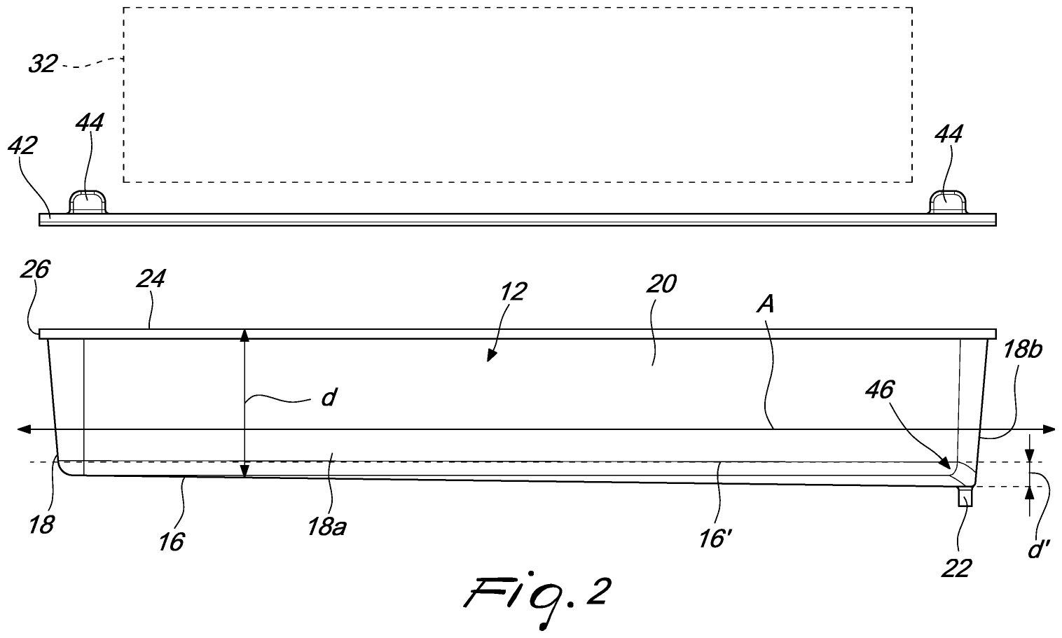

FIGS. 1 and 2 illustrate an aeroponics container 10 comprising a tray 12 and a cover 14. The cover 14 is configured to be supported by the tray 12. In one embodiment, the cover 14 forms a tight seal with the tray 12. The seal on the tray 12 can be formed around the perimeter of the cover 14. The cover 14 is configured to provide support for a plant holder (not shown). In one embodiment, the cover 14 is configured to provide support for plants that are supplied in mesh nets. The nets are rested on the cover 14. In one embodiment, the aeroponics container 10 is opaque. In one embodiment, the aeroponics container 10 can be substantially a rectangular parallelepiped.

The tray 12 comprises a non-level bottom 16 and a plurality of walls 18 extending from the non-level bottom 16. The plurality of walls 18 comprises a plurality of side walls 18a and a plurality of end walls 18b. In one embodiment, a pair of opposing side walls 18a and a pair of opposite end walls 18b are present. The side walls 18a alternate with the end walls 18b. The side walls 18a and the end walls 18b can be substantially vertical relative to the non-level bottom 16. In one embodiment, each side wall 18a and/or each end wall 18b can be inclined relative to the non-level bottom 16.

The tray 12 can have various shapes and/or sizes. The tray 12 can be configured to be housed in special frames or carriages (not shown). The tray 12 can have a standardised width and length so as to be adapted to racks provided in the frames or carriages. In one embodiment, the tray 12 can be elongate along the longitudinal axis A. In this embodiment, the end walls 18b are shorter in width than the side walls 18a.

The walls 18 and the non-level bottom 16 define a root chamber 20 that is used to accommodate the root portion of the plant. The root chamber 20 is configured to accommodate the roots of a plant that is supported by the aeroponics container 10. The roots of the plant are suspended in the root chamber 20 so as to receive the nutrient solution atomised by the nozzles. The volume of the root chamber 20 is determined by the size, shape and relative positioning of the side walls 18a, end walls 18b and non-level bottom 16.

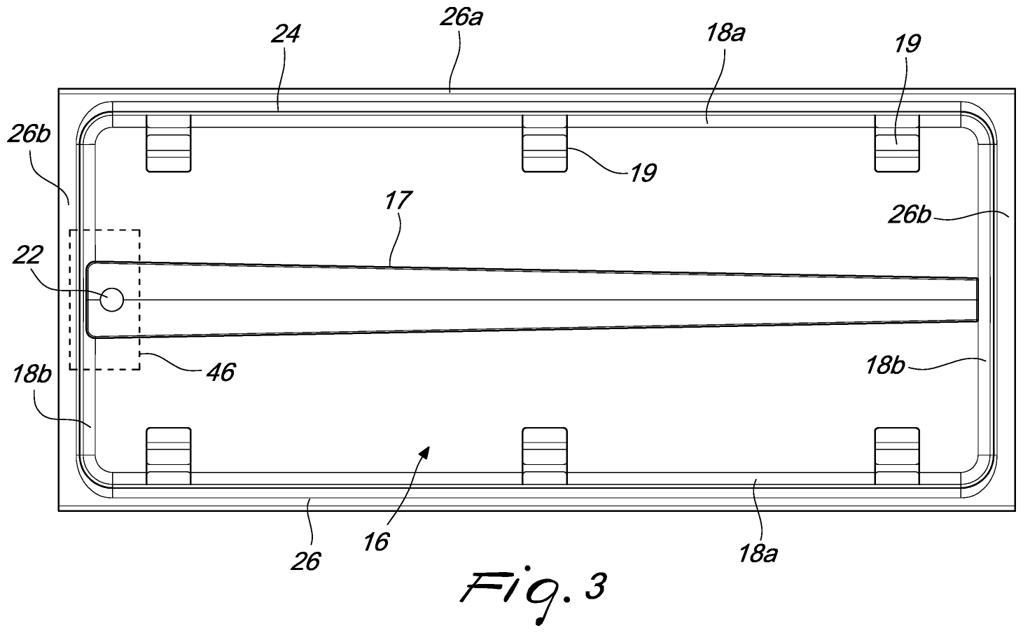

In reference to FIG. 3, the side walls 18a and/or the end walls 18b can be configured to accommodate a plurality of nozzles (not shown) for atomised spraying of a nutrient solution. The nozzles are part of the aeroponics system. The excess nutrient solution is contained in the aeroponics container 10 and accumulates on the non-level bottom 16.

Fastenings 19 are provided on the non-level bottom and side walls 18a and/or end walls 18b for the plurality of nozzles. In an alternative embodiment, the fastenings 19 can be through holes formed in the side walls 18a and/or in the end walls 18b. The spray nozzles are turned into the root chamber 20. When the atomised nutrient solution is emitted by a spray nozzle, the nebulised mist forms a cone with the apex at the orifice of the spray nozzle and spreads outward therefrom.

In reference to FIG. 3, the tray 12 has an opening 24. The opening 24 is opposite the non-level bottom 16. The opening 24 is defined by free edges 26 of the walls 18. In particular, the opening 24 is formed by free edges 26 of the side walls 18a and free edges 26 of the end walls 18b.

In one embodiment, the free edges 26 on the walls 18 extend away from the opening 24 in the form of wings. The wings 26a are configured to support the aeroponics container 10 when it is inserted in special frames or carriages. The wings 26a can be configured to be the points of contact between the aeroponics container 10 and the frames or carriages. The wings 26a can have various shapes and/or sizes. In one embodiment, the wings 26a have an arched shape. The wings 26a have a convex curvature facing a direction away from the non-level bottom 16. In an alternative embodiment, the wings 26a are linear and are substantially perpendicular to the walls 18a.

The wings 26a can be formed in place of the free edges 26 and are extensions of the walls 18a. The opening 24 is defined by the free edges 26 of the walls 18 not provided with wings and the junction between the remaining walls 18 and the wings 26a. In particular, the wings 26a are fashioned on the side walls 18a. The opening 24 is defined by the free edges 26b of the end walls 18b and the junction between the side walls 18a and the wings 26a.

In reference to FIGS. 1 to 3, a drainage outlet 22 is provided on the non-level bottom 16. The excess nutrient solution collected in the tray 12 is drained through the drainage outlet 22. In one embodiment, the drainage outlet 22 is formed like a tube extending from an outer surface of the non-level bottom 16, in a direction away from the root chamber 20. In an alternative embodiment, the drainage outlet 22 is a hole.

The drainage outlet 22 is positioned in a depression zone 46 in the non-level bottom 16. The depression zone 46 is a zone in the non-level bottom 16 that is lower than the surrounding zone. The area of the cross section of the root chamber 20 can be maximum in the depression zone 46 relative to the other areas of the cross section of the root chamber 20.

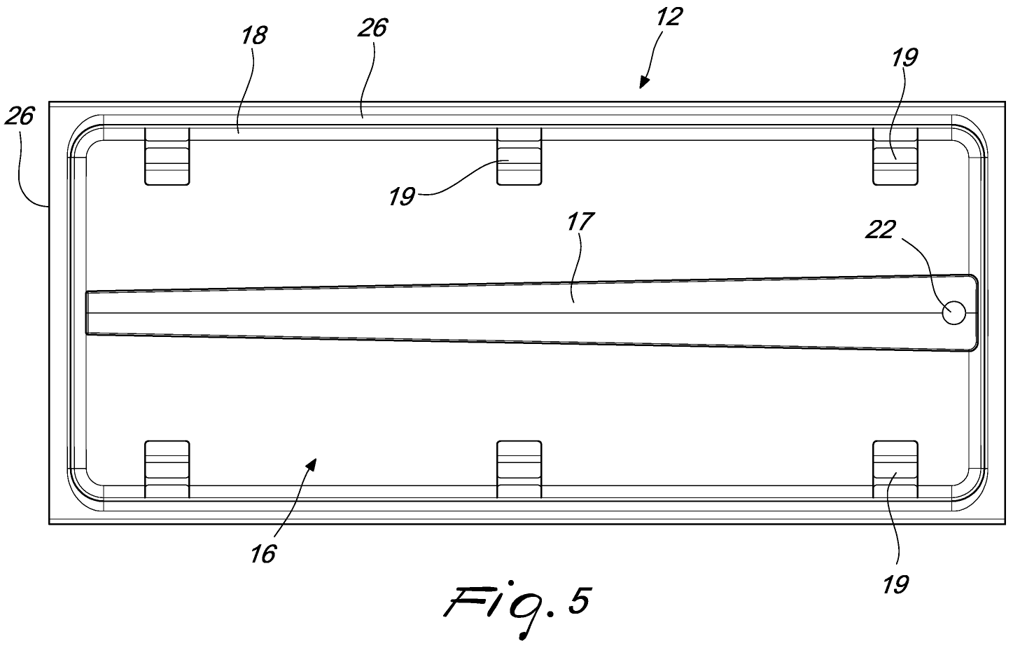

In reference to FIGS. 2 and 4 to 6, the non-level bottom 16 can be defined as non-horizontal, i.e. as having a configuration that is not parallel to a horizontal surface. A horizontal surface is a flat surface at a right angle to a plumb line. The non-level bottom 16 can be configured differently, despite being non-horizontal. Alternatively, the non-level bottom 16 can also be defined as irregular, i.e. have ridges and valleys or have projections and recesses.

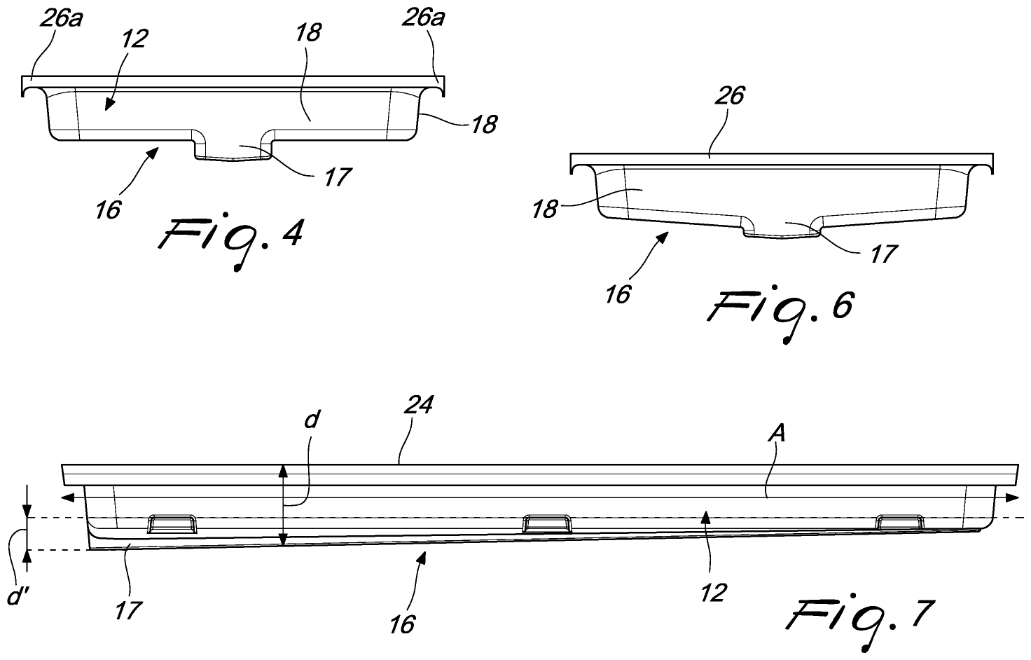

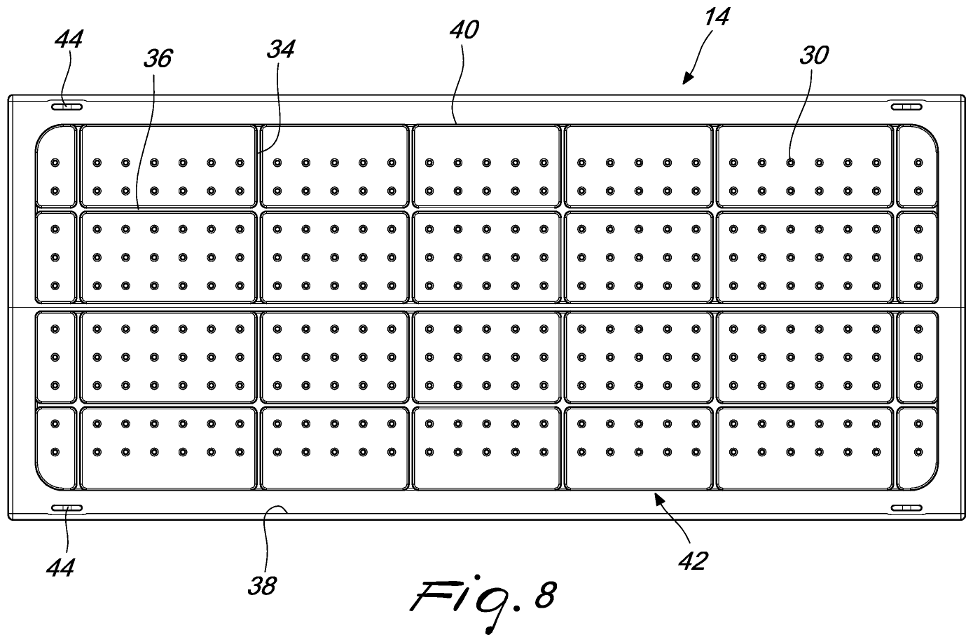

In a first embodiment, the non-level bottom 16 is planar and inclined. In reference to FIGS. 3 to 7, in first alternative embodiments, the non-level bottom 16 has at least one planar and inclined bottom section 17. The drainage outlet 22 can be situated in the bottom section 17. The bottom section 17 can be formed like a channel extending across the non-level bottom 16. In a further first alternative embodiment, the non-level bottom 16 has a plurality of planar sections and inclined bottom sections 17. The bottom sections 17 can be formed like a plurality of channels extending across the non-level bottom 16. In reference to FIG. 4, the portions of the non-level bottom 16 adjacent to the bottom section 17 are planar and not inclined. In reference to FIGS. 6 to 7, the portions of the non-level bottom 16 adjacent to the bottom section 17 are planar and inclined.

In the particular embodiment in FIGS. 6 to 7, the portions of the non-level bottom 16 adjacent to the bottom section 17 are inclined towards the bottom section 17. In FIG. 7, the portions of the non-level bottom 16 adjacent to the bottom section 17 are inclined towards the bottom section 17 and inclined along the longitudinal axis A. The inclinations of the portions of the non-level bottom 16 adjacent to the bottom section 17 provide space for fastening spray nozzles and tubes connecting to the spray nozzles. Furthermore, the inclinations enable an easy stacking of empty trays 12.

In reference to FIGS. 2 and 7, the non-level bottom 16 or the bottom section (bottom sections) 17 can be inclined relative to the plane of the opening 24. The area of the cross section of the root chamber 20 increases along the direction of inclination of the non-level bottom 16 or bottom section (bottom sections) 17. A distance d between the plane of the opening 24 and non-level bottom 16 or bottom section (bottom sections) 17 increases along the non-level bottom 16 in the direction of inclination. The depression zone 46 can be situated in the zone where the distance d between the plane of the opening 24 and non-level bottom 16 or bottom section (bottom sections) 17 is longest. Alternatively, the non-level bottom 16 or bottom section (bottom sections) 17 can be inclined relative to a wall 18 that is substantially vertical.

Again alternatively, the non-level bottom 16 or the bottom section (bottom sections) 17 are inclined on a virtual bottom plane 16′. A distance d′ between the virtual bottom plane 16′ and non-level bottom 16 or bottom section (bottom sections) 17 increases along the non-level bottom 16 or bottom section (bottom sections) 17 in the direction of inclination. The virtual bottom plane 16′ is equivalent to a bottom considered to be level, i.e. the virtual bottom plane 16′ is parallel to a horizontal surface. The virtual bottom plane 16′ is located at a junction of a wall 18 and non-level bottom 16 in which the wall 18 has the lowest height compared to the remaining walls 18.

The wall 18 can have the lowest height which is substantially continuous along the width thereof, compared to the remaining walls 18. The virtual bottom plane 16′ extends horizontally from the junction. The depression zone 46 can be situated in the zone where the distance d′ between the virtual bottom plane 16′ and non-level bottom 16 is longest. In one embodiment, the non-level bottom 16 or bottom section (bottom sections) 17 are inclined along the longitudinal axis A. The non-level bottom 16 or bottom section (bottom sections) 17 can be inclined along the direction from one end wall 18b towards an opposite end wall 18b. The non-level bottom 16 or bottom section (bottom sections) 17 can be inclined relative to an end wall 18b which is substantially vertical. The distance d between the plane of the opening 24 and non-level bottom 16 or bottom section (bottom sections) 17 can increase along the non-level bottom 16 or the bottom section (bottom sections) 17 in the direction of inclination along the longitudinal axis A. The distance d′ between the virtual bottom plane 16′ and non-level bottom 16 or bottom section (bottom sections) 17 can increase along the non-level bottom 16 or bottom section (bottom sections) 17 in the direction of inclination along the longitudinal axis A.

The non-level bottom 16 or the bottom section (bottom sections) 17 can be inclined from an end wall 18b to an opposite end wall 18b. The drainage outlet 22 is adjacent to or at an edge of the axial end of the non-level bottom 16. The drainage outlet 22 is adjacent to or at an axial end of the tray 12.

Alternatively, the inclination of the non-level bottom 16 or bottom section (bottom sections) 17 can extend partially from an end wall 18b. The inclination can terminate in a position that is spaced from the opposite end wall 18b. The inclination can terminate in a centralised position. The drainage outlet 22 is spaced from an edge of the axial end of the non-level bottom 16. The drainage outlet 22 is spaced from an axial end of the tray 12.

Again alternatively, a plurality of bottom sections 17 can extend partially from separate end walls 18b. The bottom sections 17 can converge towards the depression zone 46. The depression zone 46 can extend between the side walls 18a. The bottom sections 17 can extend towards a centralised depression zone 46 that extends between the side walls 18a. The drainage outlet 22 is positioned centrally in the depression zone 46.

In an alternative embodiment, the non-level bottom 16 or the bottom section (bottom sections) 17 are inclined in a direction transverse to the longitudinal axis A. The non-level bottom 16 or bottom section (bottom sections) 17 can be inclined along the direction from a side wall 18a towards an opposite side wall 18a. The non-level bottom 16 or bottom section (bottom sections) 17 can be inclined relative to a side wall 18a that is substantially vertical. The distance d between the plane of the opening 24 and non-level bottom 16 or bottom section (bottom sections) 17 can increase along the non-level bottom 16 in the direction of inclination transverse to the longitudinal axis A. The distance d′ between the plane of the virtual bottom plane 16′ and non-level bottom 16 or bottom section (bottom sections) 17 can increase along the non-level bottom 16 in the direction of inclination transverse to the longitudinal axis A.

The non-level bottom 16 or the bottom section (bottom sections) 17 can extend from the side wall 18a to the opposite end wall 18a. The drainage outlet 22 is adjacent or on a side edge of the non-level bottom 16. The drainage outlet 22 is adjacent or on a side of the tray 12.

Alternatively, the inclination of the non-level bottom 16 or bottom section (bottom sections) 17 can extend partially from the side wall 18a. The inclination can terminate in a position that is distant from the opposite side wall 18a. The inclination can terminate in a centralised position. The drainage outlet 22 is spaced from one side of the tray 12. The drainage outlet 22 is spaced from a side edge of the non-level bottom 16.

Again alternatively, a plurality of bottom sections 17 can extend partially from separate side walls 18a. The bottom sections 17 can converge towards the depression zone 46. The depression zone 46 can extend between the end walls 18b. The bottom sections 17 can extend towards a centralised depression zone 46 that extends between the end walls 18b. The drainage outlet 22 is positioned centrally in the depression zone 46.

In a second embodiment, the non-level bottom 16 is configured as described in the first embodiment, despite being arch-shaped rather than planar and having a curvature rather than an inclination. The area of the cross section of the root chamber 20 increases along the direction of the curvature of the non-level bottom 16 or bottom section (bottom sections) 17. A distance d between the plane of the opening 24 and non-level bottom 16 or bottom section (bottom sections) increases along the non-level bottom 16 in the direction of the curvature. Alternatively, a distance d′ between the virtual bottom plane 16′ and non-level bottom 16 or bottom section (bottom sections) 17 increases along the non-level bottom 16 or bottom section (bottom sections) in the direction of the curvature. The previous embodiments related to the first embodiment can be configured with an arch-shaped non-level bottom 16. Consequently, the second embodiment incorporates the above-described features of the first embodiment of the non-level bottom 16.

In a third embodiment, the non-level bottom 16 is configured to have a central vertex (not shown) projecting from the opening 24. The depression zone 46 is positioned at the central apex. The drainage outlet 22 is positioned at the central apex. The non-level bottom 16 is configured to converge in sections separated from the walls 18 towards the central apex. The distance d between the opening 24 and non-level bottom 16 or bottom section (bottom sections) 17 increases from each wall 18 towards the central apex. The distance d′ between the virtual bottom plane 16′ and non-level bottom 16 or bottom section (bottom sections) 17 increases from each wall 18 towards the central apex.

In reference to FIGS. 1, 2 and 8, the cover 14 is substantially planar. The cover 14 is shaped and/or sized so as to fit the tray 12. The cover 14 is removably mountable on the tray 12 so as to cover the opening 24. The walls 18 extend between the bottom 16 and cover 14. The cover 14 encloses the root chamber 20. In reference to FIG. 1, the area above the cover 14 is the vegetative zone 32 and is used to accommodate the vegetative portion of the plant. The cover 14 isolates the root chamber 20 from the vegetative zone 32 so as to eliminate the spray of nutrient solution on the vegetative zone 32. The cover 14 further prevents the nebulised nutrient solution from shifting towards the outside of the aeroponics container 10.

Furthermore, the cover 14 prevents light from entering the aeroponics container 10.

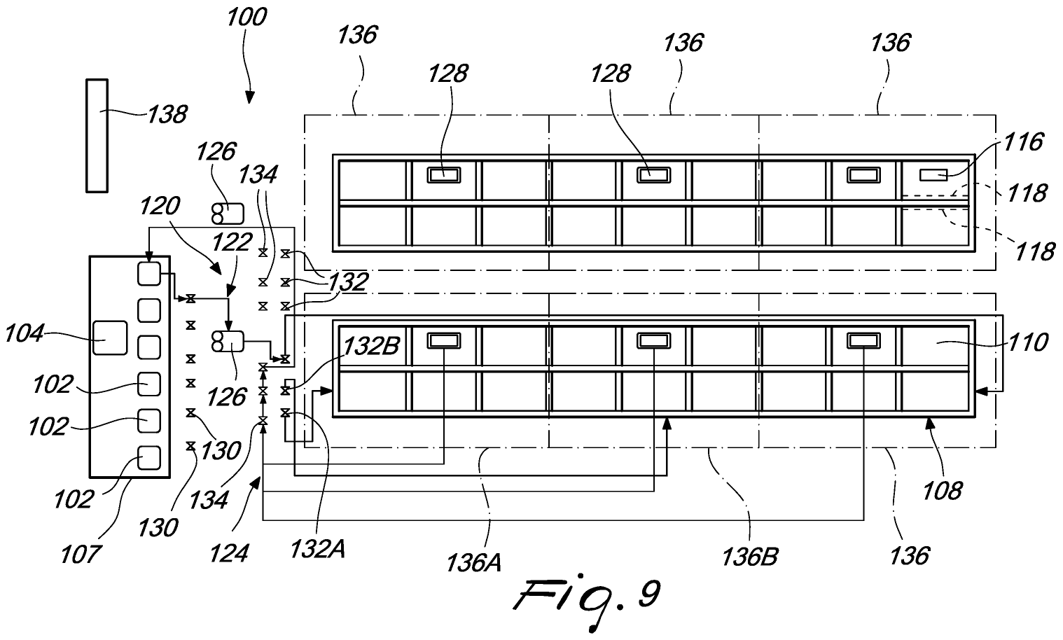

In reference to FIG. 8, the cover 14 is configured to have at least one orifice 30 for receiving a plant holder (not shown) or the roots of a plant. The at least one orifice 30 is configured to support the plant, held in the plant holder, in the correct position relative to the aeroponics container 10. Alternatively, the plant is rested on the cover 14 and the roots of the plant extend through the orifice 30. The plant can be contained in a net and rested on the cover 14.

The cover 14 is preformed without the at least one orifice 30. The cover 14 can be formed so as to allow perforations to provide the at least one orifice 30. The cover 14 is formed from a material that allows such perforations. The optimal number and/or the distribution of a plurality of orifices 30 can be determined prior to forming the orifices 30 for specific types of plants. In one embodiment, the cover 14 can be preformed with the at least one orifice 30. In a further embodiment, the cover 14 can be preformed with a plurality of orifices 30. The cover 14 can have a specific number and distribution of a plurality of orifices 30.

The cover 14 has at least one transverse rib 34 and at least one longitudinal rib 36.

The transverse rib 34 can pass through the longitudinal axis A and the longitudinal rib 36 can be parallel to the longitudinal axis A. The at least one transverse rib 34 and the at least one longitudinal rib 36 serve to provide structural rigidity to the cover 12. The transverse rib 34 and the longitudinal rib 36 can intersect. In one embodiment, a plurality of transverse ribs 34 and longitudinal ribs 36 are present. In one embodiment, the cover 14 has a reinforced perimeter edge 38. The perimeter edge 38 surrounds the cover 14 and surrounds the surface provided for the at least one orifice 30. The perimeter edge 38 imparts further structural stiffness to the cover 14. The at least one transverse rib 34 and the at least one longitudinal rib 36 can each extend between opposite sides of the perimeter edge 38. The opposite ends of the at least one transverse rib 34 can be connected to the perimeter edge 38. The opposite ends of the at least one longitudinal rib 36 can be connected to the perimeter edge 38.

The cover 14 can have at least one partition 40. The at least one partition 40 can be bound by the at least one transverse rib 34 and at least one longitudinal rib 36. In one embodiment, the cover 14 has a plurality of partitions 40. Each partition 40 is separated by the plurality of transverse ribs 34 and longitudinal ribs 36. The at least one partition 40 comprises the at least one orifice 30. In one embodiment, the partition 40 comprises a plurality of orifices 30.

In one embodiment, the partition 40 can be removably mountable on the cover 14. The cover 14 has at least one hole (not shown) formed on an upper surface 42 thereof in order to accommodate at least one partition 40. In an alternative embodiment, the cover 14 has a plurality of holes formed on the upper surface 42 thereof in order to accommodate a plurality of removable partitions 40.

The cover 14 comprises at least two grasping elements 44. The at least two grasping elements 44 are positioned at the opposite ends of the cover 14. The at least two grasping elements 44 extend from the upper surface 42 of the cover 14. In one embodiment, the cover 14 can be elongate in a direction along the longitudinal axis A of the tray 12. In this embodiment, the axial ends are shorter than the sides. The at least two grasping elements 44 are positioned on opposite sides. In an alternative embodiment, the cover 14 comprises a pair of grasping elements 44 on each side. Each pair of grasping elements 44 is positioned reciprocally spaced apart. Each element of the pair is reciprocally opposite. The grasping elements 44 are positioned along the respective sides and adjacent to each corner of the cover 14. In one embodiment, the at least two grasping elements 44 are positioned at opposite axial ends. In an alternative embodiment, the cover 14 comprises a pair of grasping elements 44 at each axial end. Each pair of grasping elements 44 is positioned reciprocally spaced apart. Each element of the pair is reciprocally opposite. The grasping elements 44 are positioned along the respective sides and adjacent to each corner of the cover 14. In one embodiment, the grasping elements 44 can each have a through hole that allows the insertion of a rod. The through holes of the grasping elements 44 that are positioned along the respective axial ends can be aligned.

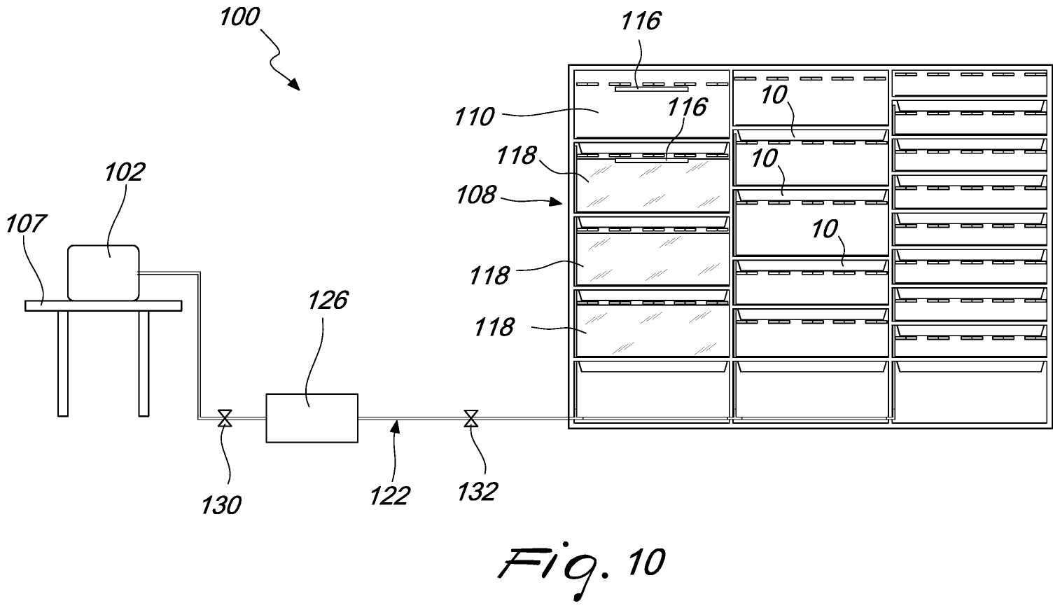

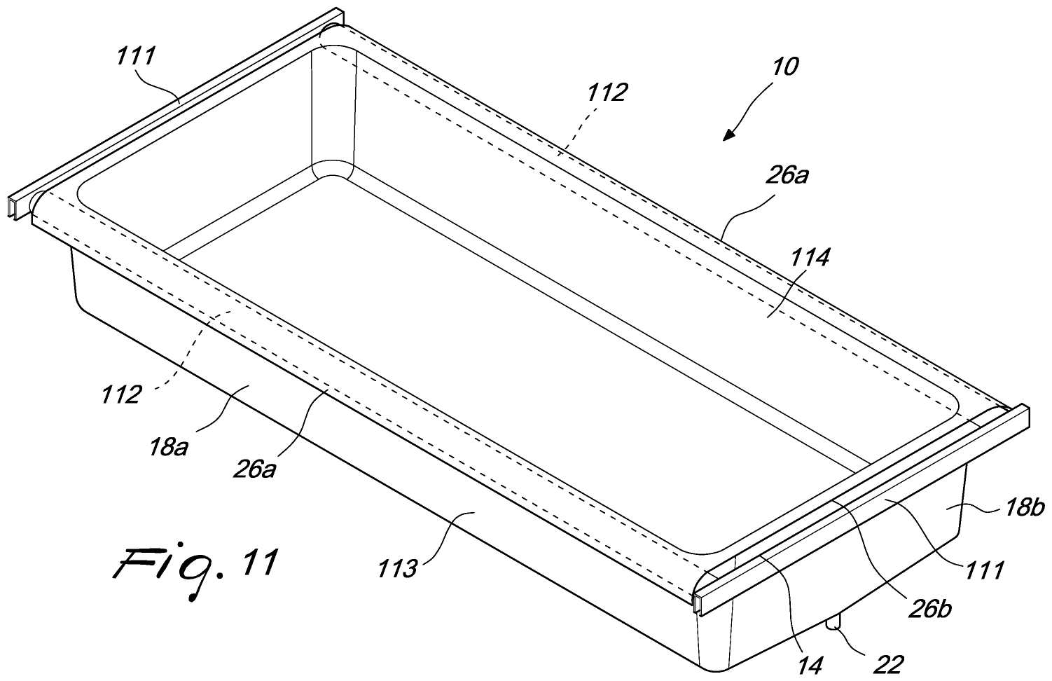

In reference to FIGS. 9 and 10, the aeroponics system 100 comprises at least one aeroponics container 10 as described above. The aeroponics system 100 comprises at least one tank 102 for a nutrient solution. The tank 102 stores the nutrient solution prior to the delivery thereof to the aeroponics container 10. In one embodiment, the aeroponics system 100 comprises a plurality of tanks 102. The tanks 102 can contain the same nutrient solution or different nutrient solutions. In one embodiment, some of the tanks 102 can contain the same or substantially the same nutrient solution whilst the remaining tanks 102 can contain different nutrient solutions. The at least one tank 102 can be supplied with distilled water from a tank of distilled water 104. The tank 102, the tank of the distilled water 104 and the container 106 can be supported on a raised platform 107.

The aeroponics system 100 comprises a supporting frame 108. The supporting frame 108 can be configured as required. The supporting frame 108 comprises at least one compartment. The supporting frame 108 comprises a plurality of compartments 110. A supporting frame 108 can comprise a plurality of compartments 110 arranged in columns and rows. The supporting frame 108 can generally be an open environment for each of the compartments 110.

In reference to FIG. 11, the compartment 110 can comprise end supports 111 and side supports 112 that engage the walls 18 or the wings 28 of the aeroponics container 10. The compartment 110 has no base. The end supports 111 and the side supports 112 define a hole 114 for the passage of the non-level bottom 16 of the tray 12.

In reference to FIGS. 9 and 10, the aeroponics system 100 comprises a light source 116. Each compartment 110 is provided with a light source 116. The light source 116 is positioned for the illumination of the area inside the compartment 110. The light source 116 can be positioned above the hole 114 in such a way that the light from the light source 116 is mainly directed towards the vegetative zone 32 when the aeroponics container 10 is placed in the compartment 110. The light source 116 can comprise a plurality of lighting units. Each lighting unit can include one or more lighting matrices. The lighting matrices that form the lighting unit can have a flat orientation or an angled orientation. The lighting unit can include light-emitting diodes (LEDs) or a fluorescent light device.

In reference to FIGS. 9 and 10, the aeroponics system 100 comprises a reflective side panel 118 for each compartment 110. The reflective side panel 118 is positioned at the side of the compartment 110. The reflective side panel 118 is removably mountable on the side of the compartment 110. The reflective side panel 118 is configured to reflect a percentage of the light emitted by the light source 116 into the compartment 110 and on the vegetative zone 32.

In reference to FIGS. 9 and 10, the aeroponics system 100 comprises a circulation manifold 120 for distribution and return of the nutrient solution between the tank 102 and the aeroponics container 10. The circulation manifold 120 comprises a distribution manifold 122 and a return manifold 124. The distribution manifold 122 comprises a distribution pump 126 configured for intermittent actuation to pump the nutrient solution into at least one aeroponics container 10. The distribution pump 126 can be activated and deactivated on demand. In one embodiment, the aeroponics system 100 can comprise further distribution pumps 126a. The distribution manifold 122 comprises nozzles connected to the aeroponics container 10 for the atomisation of nutrient fluid in the aeroponics container 10. The return manifold 124 comprises at least one return pump 128 configured for actuation to pump the nutrient solution from the at least one aeroponics container 10 to the tank 102. In one embodiment, the aeroponics system 100 can comprise a plurality of return pumps 128.

When the aeroponics system 100 comprises a tank 102 or a plurality of tanks 102, the distribution manifold 122 is configured to separately fluidly connect the tank 102 or each tank 102 of a plurality of tanks 102 to the distribution pump 126. When the aeroponics system 100 comprises a plurality of aeroponics containers 10, the distribution manifold 122 is configured to separately fluidly connect the distribution pump 126 to each aeroponics container 10. When the aeroponics system 100 comprises a plurality of aeroponics containers 10, the return manifold 124 is configured to separately fluidly connect each aeroponics container 10 to the tank 102 or one of the plurality of tanks 102.

The distribution manifold 122 comprises at least one low pressure valve 130 positioned between at least one tank 102 and the distribution pump 126. The low pressure valve 130 can be a solenoid valve. The low pressure valve 130 controls the flow of the nutrient solution from the tank 102 to the distribution pump 126. In one embodiment, the aeroponics system 100 comprises a plurality of low pressure valves 130, where each one is positioned between one of the plurality of tanks 102 and the distribution pump 126.

The distribution manifold 122 comprises at least one high pressure valve 132 positioned between the distribution pump 126 and the at least one aeroponics container 10. The high pressure valve 132 can be a solenoid valve. The high pressure valve 132 controls the flow of the nutrient solution from the distribution pump 126 to the aeroponics container 10.

In one embodiment, the aeroponics system 100 comprises a plurality of high pressure valves 132, where each one is positioned between the distribution pump 126 and one of the plurality of aeroponics containers 10.

The return manifold 124 comprises at least one return valve 134 positioned between the return pump 128 and the at least one tank 102. The return valve 134 can be a solenoid valve. The return valve 134 controls the flow of the nutrient solution not utilized by the aeroponics container 10 to the tank 102 or one of the plurality of tanks 102. In one embodiment, the aeroponics system 100 comprises a plurality of return valves 134, where each one is positioned between the return pump 128 and the tank 102 or the plurality of tanks 102.

In reference to FIG. 9, the plurality of aeroponics containers 10 are arranged into a plurality of aeroponics sectors 136. Each aeroponics sector 136 can comprise plants having the same or similar nutritional requirements. Each aeroponics sector 136 can comprise the same or similar species of plants. In one embodiment, every aeroponics sector 136 can comprise the different species of plants. The distribution manifold 122 is configured to separately fluidly connect the distribution pump 126 to each aeroponics sector 136. Each aeroponics sector 136 can be controlled by a respective high pressure valve 132. For example, the aeroponics sectors 136A, 136B can be controlled by respective high pressure valves 132A, 1328.

The aeroponics system 100 comprises a control system 138 for controlling the flow of nutrients to the aeroponics sectors 136 and the return of the nutrient solution not utilized by the aeroponics containers 10 to the tanks 102. The flow of the fluid is controlled by the control system 138 through the actuation of the distribution pump 126, return pump 128, high pressure valves 130, low pressure valves 132 and return valves 134. The control system 138 is configured to direct the flow of the nutrient solution to the aeroponics sectors 136 simultaneously or cyclically. In one embodiment, the flow of nutrient solution can be divided into phases through the aeroponics sectors 136. The aeroponics sector 136 towards which the flow of nutrients must be directed can be selected as required by the control system 138 according to the algorithm implemented.

A method for recycling a nutrient solution in the aeroponics system 100 is controlled by the control system 138. The method comprises repeating circulation cycles based on the selected aeroponics sector 136 or aeroponics sectors 136 and tank 102 or tanks 102. A circulation cycle provides for the flow of a specific nutrient solution in a predetermined tank 102 to an aeroponics sector 136 or aeroponics sectors 136 having plants that require the nutrients in the specific nutrient solution through the distribution manifold 122. The circulation cycle also involves the flow of the excess nutrient solution from the aeroponics sector 136 or aeroponics sectors 136 to the predetermined tank 102 through the return manifold 124.

In general, the method carries out a circulation cycle over a series of intermittent activation intervals, cyclically among the aeroponics sectors. After each interval, a different aeroponics sector 136 or different aeroponics sectors 136 are directed to deliver a flow of nutrients. From then on, the recycling is suspended for a second deactivation time period that is longer than the first deactivation time period. The first and second deactivation time periods can be set based on the needs associated with the aeroponics sector 136 or aeroponics sectors 136.

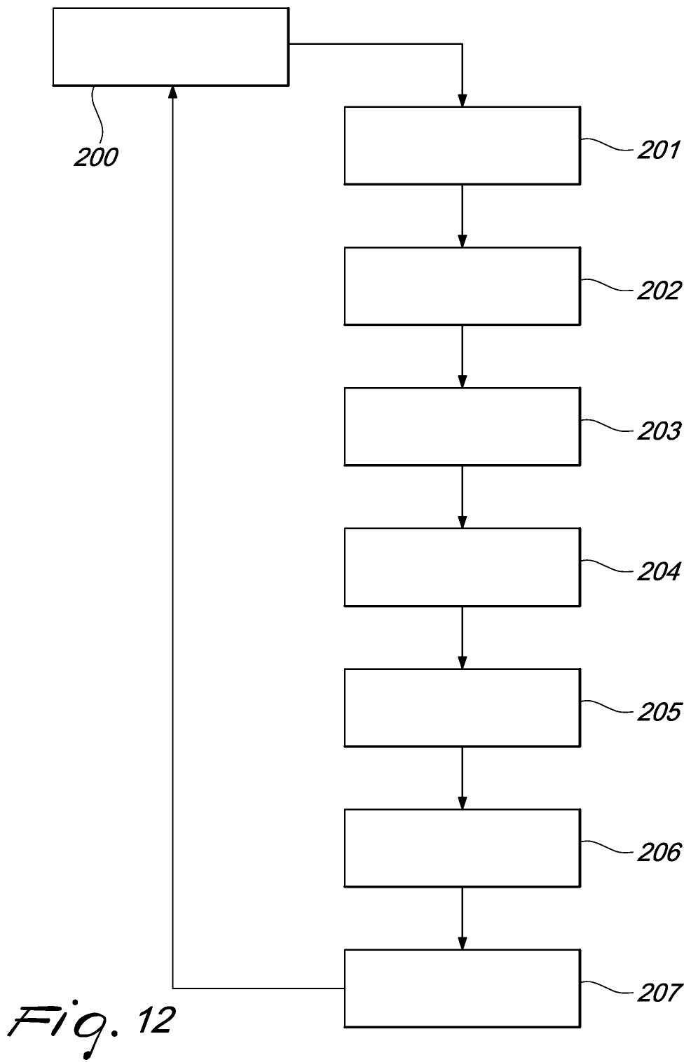

In reference to FIG. 12, the method comprises initiating a circulation cycle 200. The circulation cycle comprises the steps of:

201—Selecting a tank 102 or one of a plurality of tanks 102. The tank 102 contains a predetermined nutrient solution.

202—Selecting one of a plurality of aeroponics sectors 136 or a plurality of aeroponics sectors 136. Each aeroponics sector 136 or the aeroponics sectors 136 comprises (comprise) a plurality of aeroponics containers 10. Each aeroponics container 10 comprises at least one plant holder.

203—Fluidly connecting the selected tank 102 to the selected aeroponics sector 136 or aeroponics sectors 136 through the distribution manifold 122. This step allows the flow of the selected nutrient solution to the aeroponics sector 136 or aeroponics sectors 136.

204—Fluidly connecting the selected aeroponics sector 136 or aeroponics sectors 136 to the selected tank 102 through a return manifold 124. This step allows the return of the nutrient solution to the predetermined tank 102.

205—Pumping the nutrient solution from the selected tank 102 to the selected aeroponics sector 136 through the distribution manifold 122 over a predetermined first time period. This step allows the atomisation of the nutrient solution in the aeroponics containers 10 in the selected aeroponics sector 136 or aeroponics sectors 136. The actuation interval of the distribution pump 126 is predetermined. For example, the distribution pump 126 can be actuated for a period comprised between 5 and 30 seconds. From then on, the distribution pump 126 is deactivated.

206—Fluidly disconnecting the selected tank 102 from the selected aeroponics sector 136 or aeroponics sectors 136 through the distribution manifold 122 at the expiry of the first time period. This step disconnects the selected tank 102 from the selected aeroponics sector 136 or aeroponics sectors 136 at the end of the actuation interval of the distribution pump 126.

207—Fluidly disconnecting the selected aeroponics sector 136 or aeroponics sectors 136 from the selected tank 102 through the return manifold 124 at the expiry of a predetermined second time period. For example, the disconnection can take place after a period of 5 to 15 minutes. This step disconnects the selected aeroponics sector 136 or aeroponics sectors 136 from the selected tank 102 for an interval that extends beyond the actuation interval of the distribution pump 126. In one embodiment, the first and second time periods provide for different intervals and the first and second time periods are initiated simultaneously. In an alternative embodiment, the first and second time periods provide for the same interval, but the first and second time periods are initiated at different moments.

Finally, the method comprises the re-initiation of the circulation cycle 200, wherein the same tank 102 and aeroponics sector 136/or aeroponics sectors 136 are selected, a different tank 102 is selected, a different aeroponics sector 136/or aeroponics sectors 136 are selected or a different tank 102 and a different aeroponics sector 136/or aeroponics sectors 136 are selected.

In one embodiment, the control system 138 can re-initiate the circulation cycle 200 immediately after the completion of the previous circulation cycle 200. In an alternative embodiment, the control system 138 can re-initiate the circulation cycle 200 after a pause. Once the control system 138 can interrupt the method after the passage through all the aeroponics sectors 136, the method can be subsequently reactivated. In one embodiment, when the circulation cycle is initiated or re-initiated, a plurality of tanks 102 and/or a plurality of aeroponics sectors 136 can be selected. The circulation cycle can be interrupted as required at the end of or during the cycle.

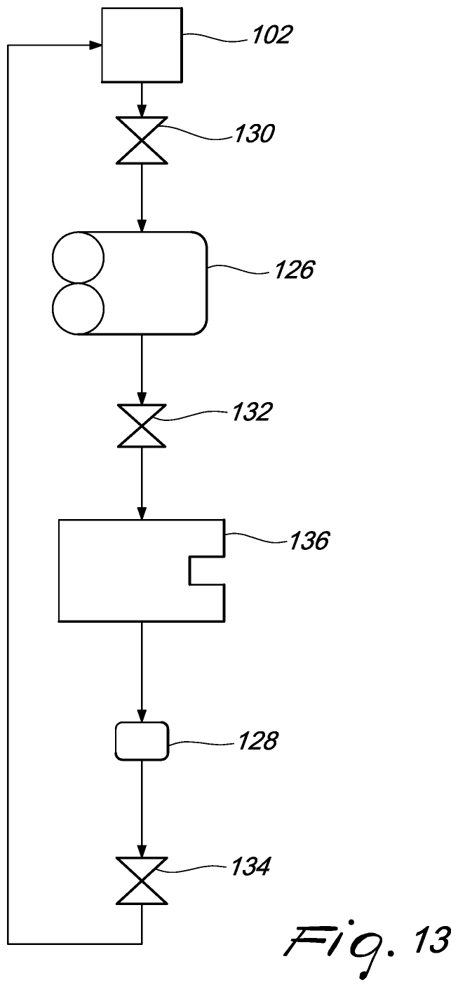

FIG. 13 illustrates the aspects of the aeroponics systems 100 involved in the circulation cycle. Step 203 further comprises opening a first low pressure valve 130 to connect one tank 102 of a plurality of tanks 102 to the distribution pump 126. This step allows the flow of the selected nutrient solution to the distribution pump 126 from the tank 102. Step 203 further comprises opening a first high pressure valve 132 which connects the distribution pump 126 to an aeroponics sector 136 or aeroponics sectors 136. This step allows the flow of the selected nutrient solution from the distribution pump 126 to the aeroponics containers 10. Step 204 opens a return valve 134 that connects the aeroponics sector 136 or aeroponics sectors 136 to the return pump 128. Step 205 comprises activating the distribution pump 126 during the predetermined first time period. Step 206 comprises closing the low pressure valve 130 and the high pressure valve 132 at or after the expiry of the first time period. Step 207 comprises closing the return valve 134 at or after the expiry of a predetermined second time period.

The skilled person will appreciate that the preceding embodiments can be modified or combined in order to obtain the aeroponics cover 10 and the aeroponics system 100 of the present invention.

### INDUSTRIAL APPLICABILITY

This disclosure describes an aeroponics container 10 that provides an increase in water use efficiency. The configuration of the tray 12 of the aeroponics container 10 enables an increase in the amount of nutrient solution collected for water recycling.

This disclosure also describes an aeroponics system 100 for growing plants with an efficient distribution of the nutrient solution to the aeroponics sectors 136. The distribution of the nutrient solution can be provided to different aeroponics sectors 136 simultaneously or cyclically. The aeroponics system 100 further provides an optimal use of light energy, thus reducing energy losses. The reflective surface 118 reduces the inefficient use of the emitted light by reflecting it onto the plants. The reflected light would otherwise be dispersed as ambient lighting.

This disclosure also describes a method for recirculating a nutrient solution through the aeroponics system 100. The method provides for gradual control in the distribution of the nutrient solution or nutrient solutions for a plurality of aeroponics sectors 136. The interval, times, temperature and/or volume of the nutrient solution sprayed into each aeroponics container 10 are controlled by the control system 138. The interval, times, temperature and/or volume of delivery of the nutrient solution to each aeroponics sector 136 are controlled by the control system 138. The above allows the use of a smaller distribution pump 126 and/or a smaller return pump 128.

Furthermore, the control over the gradual delivery of the nutrient solution allows the use of a single nutrient solution or a plurality of nutrient solutions according to need for each aeroponics sector 136. Therefore, with the possibility of different combinations of nutrient solutions, highly targeted growth conditions can be configured for different types of plants in the same aeroponics system 100.

Accordingly, this disclosure includes all of the modifications and equivalents of the subject matter set forth in the claims appended hereto, as allowed by current regulations. Furthermore, any combination of the elements described above in all of their possible variations is comprised within the invention unless otherwise indicated in the present document.

Where the technical features mentioned in any claim are followed by reference numbers, the reference numbers have been included for the sole purpose of increasing the intelligibility of the claims and, consequently, neither the reference numbers nor the absence thereof have any limiting effect on the technical features described above or the scope of any claim elements.

A person skilled in the art will realise that the invention can be incorporated in other specific forms without deviating from the invention or the essential features thereof. The preceding embodiments must thus be considered in every sense to be illustrative of the invention described herein rather than limiting it. The scope of the invention is thus indicated by the appended claims, rather than by the preceding description and all changes falling within the meaning and the range of equivalence of the claims are thus intended to be comprised therein.

1. An aeroponics container for an aeroponics system, the aeroponics container comprising:
a tray having a non-level bottom and walls defining an opening opposite the non-level bottom, at least two opposite walls having wings extending away from the opening, wherein a drainage outlet is positioned in a depression zone in the non-level bottom; and
a planar cover configured to have at least one orifice for receiving a plant holder or roots of a plant, the cover being removably mountable on the tray so as to cover the opening.

2. The aeroponics container of claim 1, wherein the non-level bottom is planar and inclined or has at least one bottom section that is planar and inclined.

3. The aeroponics container of claim 2, wherein the non-level bottom or the bottom section is inclined in a direction along a longitudinal axis and wherein the drainage outlet is spaced or adjacent to an axial end of the tray.

4. The aeroponics container of claim 2, wherein the non-level bottom or the bottom section is inclined along a direction transverse to the longitudinal axis and wherein the drainage outlet is spaced or adjacent to a transverse side of the tray.

5. The aeroponics container of claim 2, wherein the bottom sections converge towards the depression zone and wherein the drainage outlet is centrally positioned.

6. The aeroponics container of claim 1, wherein the cover has at least one orifice, at least one transverse rib and at least one longitudinal rib.

7. The aeroponics container of claim 6, wherein the cover has at least one partition bound by the at least one transverse rib and at least one longitudinal rib and wherein the partition has a plurality of orifices.

8. The aeroponics container of claim 7, wherein the partitions are removably mountable in the cover.

9. The aeroponics container of claim 1, wherein an upper surface of the cover comprises at least at least two grasping members, the at least two grasping members being positioned at opposite ends of the cover.

10. An aeroponics system comprising:
at least one aeroponics container of claim 1; at least one tank for a nutrient solution;
a supporting frame comprising at least one compartment having a light source, wherein the aeroponics container is positioned in the compartment; and
a circulation manifold for distribution and return of the nutrient solution between the tank and the aeroponics container.

11. The aeroponics system of claim 10, wherein the circulation manifold comprises a distribution manifold (122) and a return manifold, wherein the distribution manifold comprises a distribution pump configured for intermittent actuation to pump the nutrient solution to the at least one aeroponics container.

12. The aeroponics system of claim 11, comprising a plurality of tanks, wherein the distribution manifold is configured to separately fluidly connect each tank to the distribution pump.

13. The aeroponics system of claim 11, comprising a plurality of aeroponics containers, wherein the distribution manifold is configured to separately fluidly connect the distribution pump to each aeroponics container.

14. The aeroponics system of claim 13, wherein the plurality of aeroponics containers are arranged into a plurality of aeroponics sectors and wherein the distribution manifold is configured to separately fluidly connect the distribution pump.

15. A method to recycle nutrient solution in the aeroponics system, the method comprising the steps of:
initiating a circulation cycle comprising:
selecting a tank or one of a plurality of tanks, each tank containing a predetermined nutrient solution;
selecting one of a plurality of aeroponics sectors, each aeroponics sector comprising a plurality of aeroponics containers according to claim 1, wherein each aeroponics container comprises at least one plant holder;
fluidly connecting the selected tank to the selected aeroponics sector through a distribution manifold; a step of fluidly connecting the selected aeroponics sector to the selected tank through a return manifold;
pumping the nutrient solution from the selected tank to the selected aeroponics sector through the distribution manifold over a predetermined first time period;
fluidly disconnecting the selected tank from the selected aeroponics sector through the distribution manifold at the expiry of the first time period; and
fluidly disconnecting the selected aeroponics sector from the selected tank through the return manifold at the expiry of a predetermined second time period; and
re-initiating the circulation cycle, wherein the same tank and aeroponics sector are selected, a different tank is selected, a different aeroponics sector is selected or a different tank and a different aeroponics sector are selected.
